(19) United States
(12) Patent Application Publication
(10) Pub. No.: US 2012/0037478 A1
(43) Pub. Date: Feb. 16, 2012

(54) ROLLER CONVEY SYSTEM

(75) Inventors: Tai-Hung SHIH, Taipei City (TW); Yu-Hsiang HUNG, Hsinchu City (TW); Jung-Chin HSU, Taipei County (TW)

(73) Assignee: Du Pont Apollo Limited, Hong Kong (HK)

(21) Appl. No.: 13/183,443

(22) Filed: Jul. 15, 2011

Related U.S. Application Data
(60) Provisional application No. 61/372,465, filed on Aug. 11, 2010.

(51) Int. Cl. B65G 39/04; B65G 13/02

(52) U.S. Cl. 198/780; 198/789

(57) ABSTRACT

A convey system includes at least three rotatable shafts disposed in substantial parallel with one another. A pair of first rollers are disposed at each of the at least three rotatable shafts. A first distance between the pair of first rollers is fixed at each of the at least three rotatable shafts. At least a pair of second rollers are disposed between the pair of first rollers at each of the at least three rotatable shafts. A second distance between the pair of second rollers is varied at each of the at least three rotatable shafts. The second distance between the pair of second rollers is shortest at a middle one or two of the at least three rotatable shafts and increased gradually from thereof to two opposite ends of the at least three rotatable shafts. In order to prevent the substrate from sliding on the first and second rollers, a sandblasted treating or a roughness coating is applied on an outer surface of the first and second rollers.

### RELATED APPLICATIONS

This application claims priority to U.S. Provisional Application Ser. No. 61/372,465, filed Aug. 11, 2010, which is herein incorporated by reference.

### BACKGROUND

1. Field of Invention

The present invention relates to a convey system, and more particularly relates to a roller convey system.

2. Description of Related Art

Various conveyors and guide tracks have been proposed in the art. In particular, mechanical conveyors have been used in the industry for transporting articles from one part of, for example, an industrial plant or warehouse to another. The more commonly used conveyors are the ones which transport goods in cartons, boxes and the like.

The roller convey system used in modem clean rooms requires goods to be transported exactly along a desired direction and to be transported with a controlled and uniform speed. A conventional roller in the convey system pose limitations and difficulties in transporting goods exactly along a desired direction. For the forgoing reasons, there is a need for improving a conventional roller convey system.

### SUMMARY

In one aspect of the present invention, a convey system includes at least three rotatable shafts disposed in substantial parallel with one another. A pair of first rollers are disposed at each of the at least three rotatable shafts. A first distance between the pair of first rollers is fixed at each of the at least three rotatable shafts. At least a pair of second rollers are disposed between the pair of first rollers at each of the at least three rotatable shafts. A second distance between the pair of second rollers is varied at each of the at least three rotatable shafts. The second distance between the pair of second rollers is shortest at a middle one or two of the at least three rotatable shafts and increased gradually from thereof to two opposite ends of the at least three rotatable shafts.

In another aspect of the present invention, a convey system includes a chamber and three rotatable shafts at least. The chamber includes an inlet and an outlet. The at least three rotatable shafts are disposed in substantial parallel with one another within the chamber. A pair of first rollers are disposed at each of the at least three rotatable shafts. A first distance between the pair of first rollers is fixed at each of the at least three rotatable shafts. At least a pair of second rollers are disposed between the pair of first rollers at each of the at least three rotatable shafts. A second distance between the pair of second rollers is varied at each of the at least three rotatable shafts. The second distance between the pair of second rollers is longest at one of the at least three rotatable shafts, which is closest to the inlet or outlet of the chamber and decreased gradually from thereof to one of the at least three rotatable shafts, which is farthest from the inlet and outlet of the chamber.

In an embodiment disclosed herein, each of the first rollers has an outer rough surface.

In another embodiment disclosed herein, each of the second rollers has an outer rough surface.

In another embodiment disclosed herein, each of the at least three rotatable shafts has a plurality of concave scales to be fastened by the first roller or second roller.

In another embodiment disclosed herein, each of the first rollers has an outer surface of an average roughness Ra ranging from about 0.5 μm to about 30 μm.

In another embodiment disclosed herein, each of the first rollers has an outer surface of an average roughness Ra ranging from about 2 μm to about 8 μm.

In another embodiment disclosed herein, each of the second rollers has an outer surface of an average roughness Ra ranging from about 0.5 μm to about 30 μm.

In another embodiment disclosed herein, each of the second rollers has an outer surface of an average roughness Ra ranging from about 2 μm to about 8 μm.

In another embodiment disclosed herein, the at least three rotatable shafts are driven by a transmission mechanism.

In another embodiment disclosed herein, each of the at least three rotatable shafts has two opposite ends rotatable connected with a wall of the chamber.

In another embodiment disclosed herein, the first roller has a larger radius than the second roller does.

In still another aspect of the present invention, a convey system includes at least nine rotatable shafts disposed in substantial parallel with one another. A pair of first rollers are disposed at each of the at least nine rotatable shafts. A first distance between the pair of first rollers is fixed at each of the at least nine rotatable shafts. At least a pair of second rollers are disposed between the pair of first rollers at each of the at least nine rotatable shafts. A second distance between the pair of second rollers is varied at each of the at least nine rotatable shafts. The second distance between the pair of second rollers is relatively short at a middle one and two opposite ends of the at least nine rotatable shafts and increased gradually and then decreased gradually from the middle one to the two opposite ends of the at least nine rotatable shafts.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a cross-sectional view of a convey system according to one embodiment of this invention;

FIG. 2 illustrates a rotatable shaft of the convey system according to another embodiment of this invention;

FIG. 3 illustrates a side view of a substrate transferred by a convey system according to another embodiment of this invention;

FIG. 4 illustrates a perspective view of a roller of the convey system according to still another embodiment of this invention;

FIG. 5 illustrates a cross-sectional view of a convey system according to another embodiment of this invention; and

FIG. 6 illustrates a cross-sectional view of a convey system according to another embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

A convey system disclosed herein is to transfer a substrate, e.g. a glass substrate or a semiconductor substrate, by means of rollers along a desired direction and to avoid uncontrolled sliding upon the roller's surface.

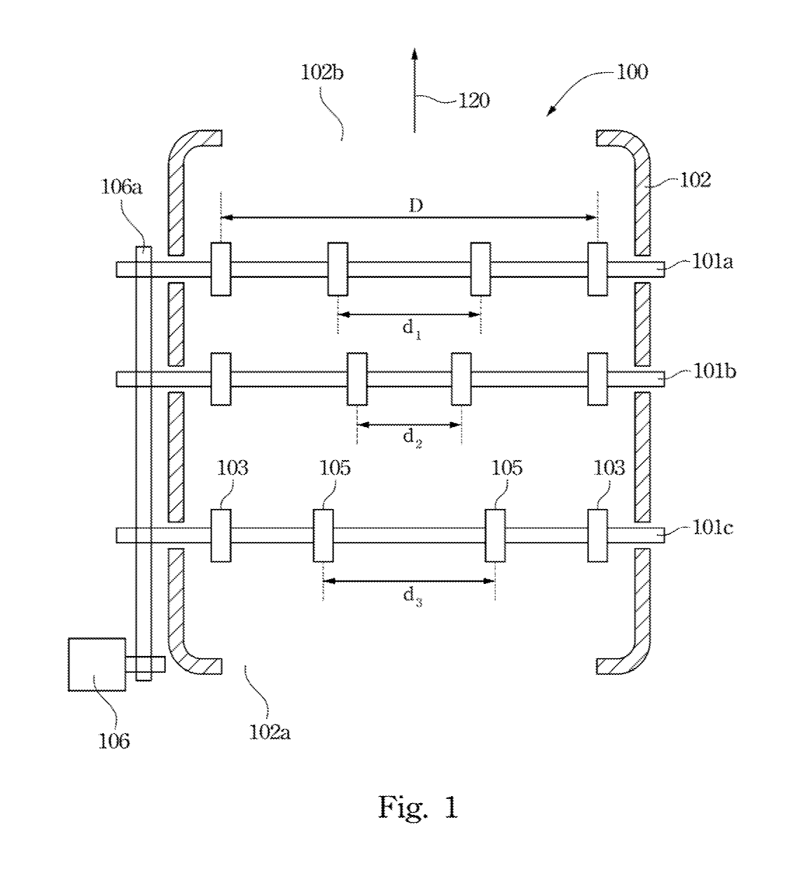

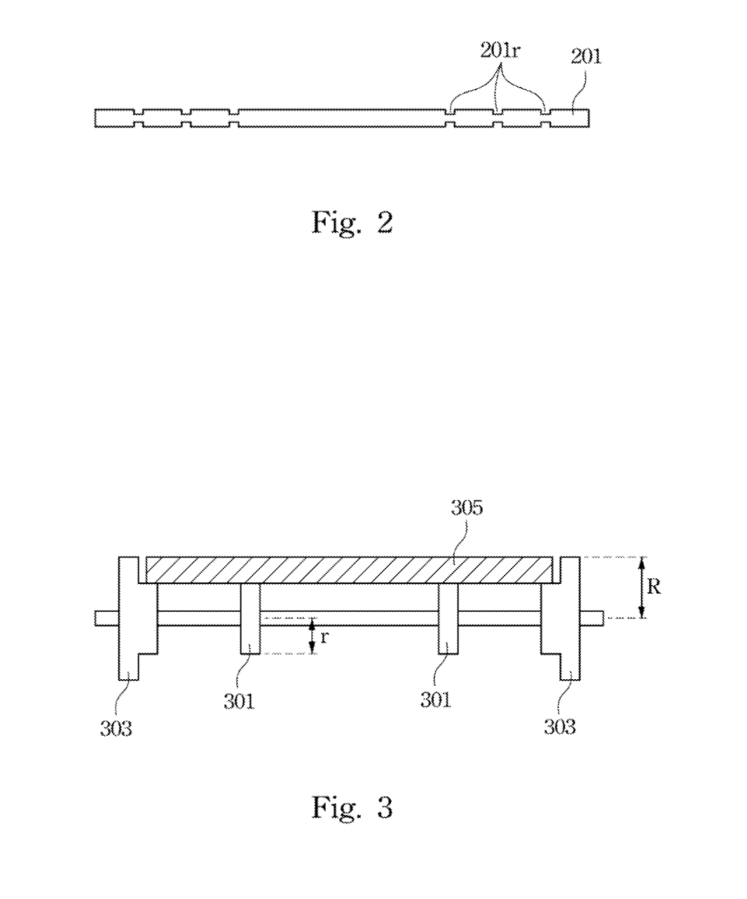

Referring to FIG. 1, which illustrates a cross-sectional view of a convey system 100 according to one embodiment of this invention. The convey system 100 includes a chamber 102 and at least three rotatable shafts (101a, 101b, installed inside the chamber 102. Each rotatable shaft (101a, 101b, 101c) is equipped with rollers (103, 105), which are specially positioned to control a desired transferring direction. Each rotatable shaft (101a, 101b, 101c) is equipped with a pair of rollers 103, which has a fixed distance D between thereof. The distance D should be slightly longer than a width of a substrate (also referring to substrate 305 in FIG. 3) such that the substrate can be transferred along a desired direction 120 and between the pair of rollers 103. Each rotatable shaft (101a, 101b, 101c) is further equipped with at least a pair of rollers 105 (i.e. two or more pair of rollers 105 are also applicable), which has a varied distance between thereof. The distance between the pair of rollers 105 is shortest (e.g. the distance d₂) at a middle one or two of the at least three rotatable shafts (e.g. the rotatable shaft 101b) and increased gradually (e.g. the distances d₁ and d₃) from thereof to two adjacent opposite ends (e.g. the rotatable shafts 101a and 101c) of the at least three rotatable shafts. That is, the distance between the pair of rollers 105 is longest (e.g. the distance d₁ or d₃) at one (e.g. the rotatable shaft 101a or 101c) of the at least three rotatable shafts, which is closest to the inlet 102a or outlet 102b of the chamber 102 and decreased gradually from thereof to one (e.g. the rotatable shaft 101b) of the at least three rotatable shafts, which is farthest from the inlet 102a and outlet 102b of the chamber 102. In this embodiment, the distance d₁ can be equal to or not equal to the distance d₃. With such design, a substrate can be precisely transferred along the desired direction 120 and its weight can be evenly distributed by all the rollers 103 and 105. Besides, a transmission mechanism comprises at least a motor 106, a transmission belt and/or at least a transmission gear 106a, which is installed to drive the three rotatable shafts (101a, 101b, 101c), wherein each rotatable shaft has its two opposite ends rotatably connected with a chamber wall of the chamber 102 or laid on a support set. In an alternate embodiment, the convey system 100 can also be operated without the chamber 102, e.g. not within a vacuum chamber.

Referring to FIG. 2, which illustrates a rotatable shaft 201 of the convey system according to another embodiment of this invention. The rotatable shaft 201 is equipped with several concave scales 201r such that the rollers (e.g. rollers 103 and 105 as illustrated in FIG. 1) can be easily fastened at a position where a concave scale 201r is located to vary the distance between a pair of rollers. The roller (e.g. rollers 103 and 105 as illustrated in FIG. 1) can be more reliably secured to the concave scale 201r compared with a rotatable shaft without concave scales.

Referring to FIG. 3, which illustrates a side view of a substrate transferred by a convey system according to another embodiment of this invention. When a substrate 305 is supported and transferred by rollers 301 and 303, the substrate 305 is positioned between the two rollers 303 such that the substrate 305 would not transferred out of the area between the two rollers 303. A substrate may be supported by the two rollers 303 (referring the substrate 305 as illustrated in FIG. 3) or not supported by the two rollers 303 (e.g. a substrate with a shorter width is only supported by the rollers 301). In this embodiment, the rollers 303 have a longer radius R and the rollers 301 have a shorter radius r such that the substrate 305 can be restricted between the two rollers 303 and supported both by the rollers 301 and 303.

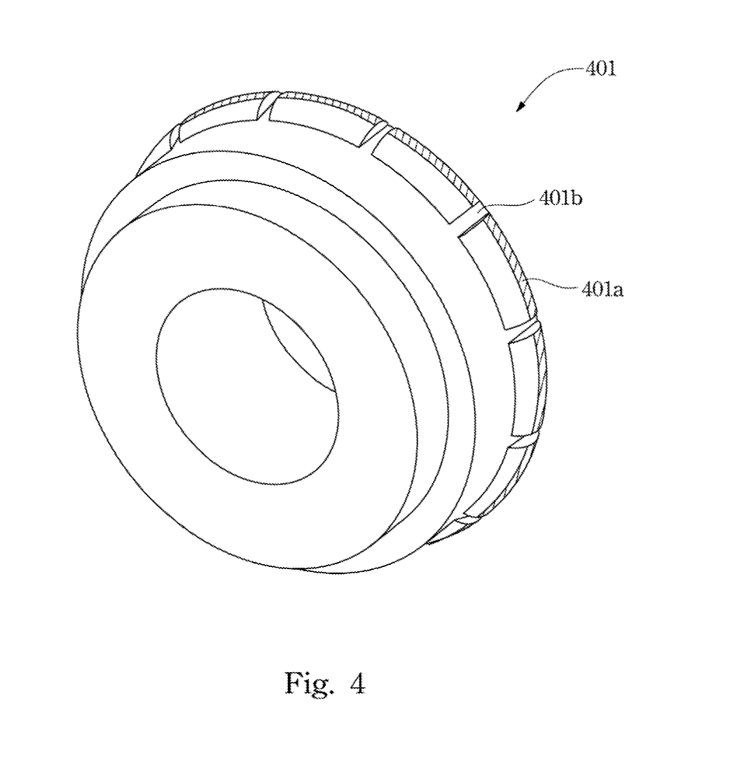

Referring to FIG. 4, which illustrates a perspective view of a roller 401 of the convey system according to still another embodiment of this invention. In order to avoid uncontrolled sliding of a substrate upon the roller's surface, the roller 401 is specially treated and designed. In particular, an outer surface of the roller 401 is treated to have an average roughness Ra ranging from about 0.5 μm to about 30 μm by sandblasting or other applicable process. In an alternate embodiment, a roughness coating may be formed on the outer surface of the roller 401. It is preferred that the outer surface of the roller 401 is treated to have an average roughness Ra ranging from about 2 μg in to about 8 μm such that the substrate can be transported smoothly with the least sliding. Besides, the outer surface of the roller 401 can be designed to have “flat-top mountains 401a” and “valleys 401b” so as to provide a better support and avoid uncontrolled sliding for a substrate thereon. In this embodiment, the flat-top mountains 401a may also be treated to have a rough surface with an average roughness Ra ranging from about 0.5 μm to about 30 μm or preferably ranging from about 2 μm to about 8 μm

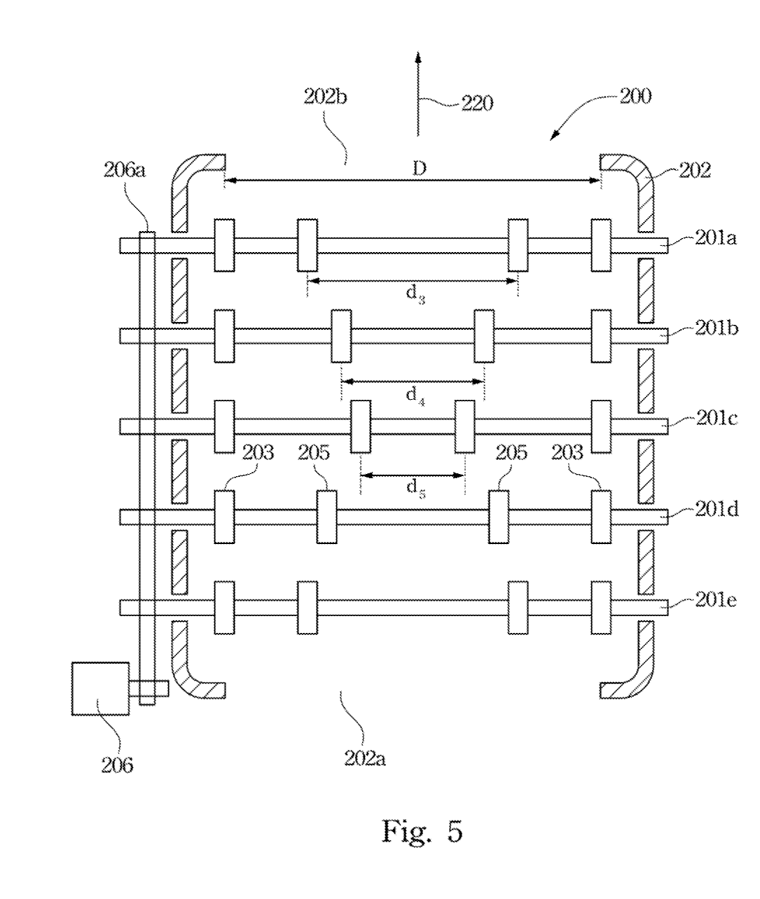

FIG. 5 illustrates a cross-sectional view of a convey system according to another embodiment of this invention. The convey system 200 is different from the convey system 100 in that the convey system 200 includes 5 rotatable shafts (201a, 201b, 201c, 201d, 201e). The convey system 200 includes a chamber 202 and 5 rotatable shafts (201a, 201b, 201c, 201d, 201e) installed inside a chamber 202. Five rotatable shafts (201a, 201b, 201c, 201d, 201e) can be uniformly arranged, e.g. with the same pitch between adjacent two rotatable shafts. Each rotatable shaft (201a, 201b, 201c, 201d, 201e) is equipped with rollers (203, 205), which are specially positioned to control a desired transferring direction. Each rotatable shaft (201a, 201b, 201c, 201d, 201e) is equipped with a pair of rollers 203, which has a fixed distance D between thereof. The distance D should be slightly longer than a width of a substrate (also referring to substrate 305 in FIG. 3) such that the substrate can be transferred along a desired direction 220 and between the pair of rollers 203. Each rotatable shaft (201a, 201b, 201c, 201d, 201e) is further equipped with at least a pair of rollers 205 (i.e. two or more pairs of rollers 205 are also applicable), which has a varied distance between thereof. The distance between the pair of rollers 205 is shortest (e.g. the distance d₅) at a middle one or two of the five rotatable shafts (e.g. the rotatable shaft 201c) and increased gradually (e.g. the distances d₃ and d₄) from thereof to two adjacent opposite ends (e.g. the rotatable shafts 201a, 201b, 201d, 201e) of the five rotatable shafts. That is, the distance between the pair of rollers 205 is longest (e.g. the distance d₃) at one (e.g. the rotatable shaft 201a or 201e) of the five rotatable shafts, which is closest to the inlet 202a or outlet 202b of the chamber 202 and decreased gradually from thereof to one (e.g. the rotatable shaft 201c) of the five rotatable shafts, which is farthest from the inlet 202a and outlet 202b of the chamber 202. With such design, a substrate can be precisely transferred along the desired direction 220 and its weight can be evenly distributed by all the rollers 203 and 205. Besides, a motor 206 is installed to drive the five rotatable shafts (201a, 201b, 201c, 201d, 201e), which each has its two opposite ends rotatably connected with a chamber wall of the chamber 202 or laid on a support set, by means of a transmission belt or transmission gear 206a.

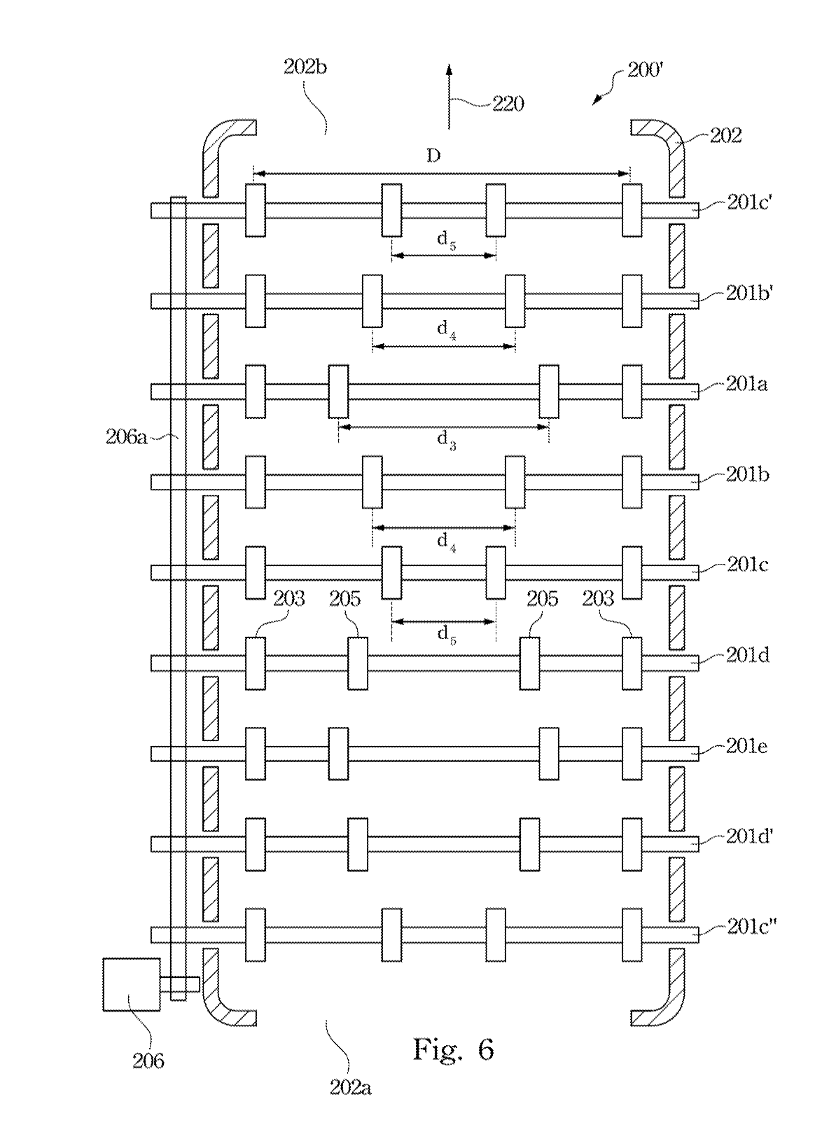

FIG. 6 illustrates a cross-sectional view of a convey system 200′ according to still another embodiment of this invention. The convey system 200′ is different from the convey system 200 in that the convey system 200′ includes nine rotatable shafts (201a, 201b, 201c, 201d, 201e, 201c′, 201c″, 201b′, 201d′). The convey system 200′ includes a chamber 202 and nine rotatable shafts installed inside the chamber 202. The nine rotatable shafts can be uniformly arranged, e.g. with the same pitch between adjacent two rotatable shafts. Each rotatable shaft (201a, 201b, 201c, 201d, 201e, 201c′, 201c″, 201b′, 201d′) is equipped with rollers (203, 205), which are specially positioned to control a desired transferring direction. Each rotatable shaft is equipped with a pair of rollers 203, which has a fixed distance D between thereof. The distance D should be slightly longer than a width of a substrate (also referring to substrate 305 in FIG. 3) such that the substrate can be transferred along a desired direction 220 and between the pair of rollers 203. Each rotatable shaft is further equipped with at least a pair of rollers 205 (i.e. two or more pairs of rollers 205 are also applicable), which has a varied distance between thereof. The distance between the pair of rollers 205 is shortest or relatively short (e.g. the distance d₅) at a middle one (e.g. the rotatable shaft 201c) and two opposite ends (e.g. the rotatable shafts 201c′ and 201c″) of the nine rotatable shafts, and increased gradually and then decreased gradually (e.g. d₅=>d₄=>d₃=>d₄=>d₅) from the middle one to two adjacent opposite ends of the nine rotatable shafts. With such design, a substrate can be precisely transferred along the desired direction 220 and its weight can be evenly distributed by all the rollers 203 and 205. Furthermore, a motor 206 is installed to drive the nine rotatable shafts, which each has its two opposite ends rotatably connected with a chamber wall of the chamber 202 or laid on a support set, by means of a transmission belt or transmission gear 206a.

According to the above-discussed embodiments, the convey system is equipped with rollers, which are specially positioned to guide a substrate along a desired direction and are specially treated to have an outer rough surface with a proper roughness to avoid uncontrolled sliding of the substrate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A convey system comprising:
at least three rotatable shafts disposed in substantial parallel with one another;
a pair of first rollers disposed at each of the at least three rotatable shafts, a first distance between the pair of first rollers is fixed at each of the at least three rotatable shafts; and
at least a pair of second rollers disposed between the pair of first rollers at each of the at least three rotatable shafts, a second distance between the pair of second rollers is varied at each of the at least three rotatable shafts,
wherein the second distance between the pair of second rollers is shortest at a middle one or two of the at least three rotatable shafts and increased gradually from thereof to two opposite ends of the at least three rotatable shafts.

2. The convey system of claim 1, wherein each of the first rollers has an outer rough surface.

3. The convey system of claim 1, wherein each of the second rollers has an outer rough surface.

4. The convey system of claim 1, wherein each of the at least three rotatable shafts has a plurality of concave scales to be fastened by the first roller or second roller.

5. The convey system of claim 1, wherein each of the first rollers has an outer surface of an average roughness Ra ranging from about 0.5 μm to about 30 μm.

6. The convey system of claim 1, wherein each of the second rollers has an outer surface of an average roughness Ra ranging from about 0.5 μm to about 30 μm.

7. The convey system of claim 1, wherein each of the first rollers has an outer surface of an average roughness Ra ranges from about 2 μm to about 8 m.

8. The convey system of claim 1, wherein each of the second rollers has an outer surface of an average roughness Ra ranges from about 2 μm to about 8 μm.

9. The convey system of claim 1, wherein the at least three rotatable shafts are driven by a transmission mechanism.

10. The convey system of claim 1, wherein the first roller has a larger radius than the second roller does.

11. A convey system comprising:
a chamber comprising an inlet and an outlet;
at least three rotatable shafts disposed in substantial parallel with one another within the chamber;
a pair of first rollers disposed at each of the at least three rotatable shafts, a first distance between the pair of first rollers is fixed at each of the at least three rotatable shafts; and
at least a pair of second rollers disposed between the pair of first rollers at each of the at least three rotatable shafts, a second distance between the pair of second rollers is varied at each of the at least three rotatable shafts,
wherein the second distance between the pair of second rollers is longest at one of the at least three rotatable shafts, which is closest to the inlet or outlet of the chamber and decreased gradually from thereof to one of the at least three rotatable shafts, which is farthest from the inlet and outlet of the chamber.

12. The convey system of claim 11, wherein each of the first rollers has an outer rough surface.

13. The convey system of claim 11, wherein each of the second rollers has an outer rough surface.

14. The convey system of claim 11, wherein each of the at least three rotatable shafts has a plurality of concave scales to be fastened by the first roller or second roller.

15. The convey system of claim 11, wherein each of the first rollers has an outer surface of an average roughness Ra ranging from about 0.5 m to about 30 μm.

16. The convey system of claim 11, wherein each of the second rollers has an outer surface of an average roughness Ra ranging from about 0.5 μm to about 30 μm.

17. The convey system of claim 11, wherein each of the first rollers has an outer surface of an average roughness Ra ranges from about 2 μm to about 8 μm.

18. The convey system of claim 11, wherein each of the second rollers has an outer surface of an average roughness Ra ranges from about 2 μm to about 8 μm.

19. The convey system of claim 11, wherein each of the at least three rotatable shafts has two opposite ends rotatably connected with a wall of the chamber.

20. The convey system of claim 11, wherein the first roller has a larger radius than the second roller does.

21. A convey system comprising:
a chamber comprising an inlet and an outlet;
at least nine rotatable shafts disposed in substantial parallel with one another within the chamber;
a pair of first rollers disposed at each of the at least nine rotatable shafts, a first distance between the pair of first rollers is fixed at each of the at least nine rotatable shafts; and
at least a pair of second rollers disposed between the pair of first rollers at each of the at least nine rotatable shafts, a second distance between the pair of second rollers is varied at each of the at least nine rotatable shafts,
wherein the second distance between the pair of second rollers is relatively short at a middle one and two opposite ends of the at least nine rotatable shafts and increased gradually and then decreased gradually from the middle one to the two opposite ends of the at least nine rotatable shafts.
